(19) United States
(12) Patent Application Publication
(10) Pub. No.: US 2021/0352769 A1
(43) Pub. Date: Nov. 11, 2021

(54) PTC Heating Device and Method of Using Same

(71) Applicant: Eberspächer catem GmbH & Co. KG, Herxheim (DE)

(72) Inventors: Kurt Walz, Hagenbach (DE); Sascha Barner, Hagenbach (DE); Herbert Weisenburger, Neuburg am Rhein (DE)

(21) Appl. No.: 17/307,384

(22) Filed: May 4, 2021

(30) Foreign Application Priority Data
May 5, 2020 (DE) 10 2020 205 646.3

(51) Int. Cl. H05B 3/22

(52) U.S. Cl. CPC H05B 3/22

(57) ABSTRACT

A PTC heating device directly converts electrical energy in the form of a DC voltage of a photovoltaic module into heat. This heat may be introduced into a circuit in which at least one heat-emitting heat exchanger is integrated, for example, in the form of a radiator. The heat exchange may be located in or on a structure such as a building.

### BACKGROUND OF THE INVENTION

### 1. Field of the Invention

The present invention relates to a novel use of a PTC heating device.

### 2. Background of the Invention

PTC heating devices are known in particular as air or water heaters in a motor vehicle. EP 3 334 242 A1 and a U.S. counterpart 10,724,736, disclose an electric heating device. Both of these documents are incorporated by reference by way of background material. In this device, PTC heating devices are inserted into a receptacle of a partition wall and are plug-contacted in a sealed manner to the partition wall. The partition wall separates a connection chamber from a heating chamber. Disposed on the side facing away from the heating chamber and inside the connection chamber is a device for contacting several PTC heating devices. This PTC heating devices each comprise a frame, in the frame opening of which at least one PTC element is received. The PTC element is provided on both sides with contact plates forming conductor tracks. These contact plates can be provided in different ways with respect to the heating chamber in such a way that they do not come into contact with the medium to be heated.

### SUMMARY

The present invention also makes use of this general structure. The PTC heating device can also be inserted into a receiving pocket or recess which projects from the partition wall in the direction toward the heating chamber and which is completely closed. Such a construction is disclosed in EP 1 872 986 A1 and U.S. Pat. No. 8,946,599, the subject matter of each of which is incorporated by reference by way of background. The PTC heating device can also each have an outer enclosure that encloses the PTC element and the conductor tracks and accommodates them in an electrically insulating manner with respect to the enclosure, for example, by providing insulation on the outer side of the PTC element or in that the conductor tracks or these elements are accommodated between insulating ceramic plates or other insulating elements, see EP 1 916 873 A1 and related U.S. Pat. No. 8,395,088 or EP 1 931 176 A1 and related U.S. Pat. No. 8,183,505, the subject matter of each of which is incorporated by reference by way of background.

The present invention proposes a novel use of such a PTC heating device. The PTC heating device as such can implement the features discussed above or make use of other known structural principles. In particular, use is made of configurations in which the PTC element can be a cuboid or plate-shaped semiconductor made of ceramic and/or the heating chamber is itself circumferentially closed and opened only to the outside by way of connection ports for the inlet and outlet of fluid into the heating chamber, where the PTC element and the conductor tracks energizing the PTC element are insulated against the heating chamber so that the medium to be heated does not come into contact with the current-carrying elements of the PTC heating device, see EP 2 440 004 A1 and related U.S. Pat. No. 9,161,391, the subject matter of each of which is incorporated by reference by way of background.

A photovoltaic module generates direct voltage. The amount of voltage generated in photovoltaic modules depends on the irradiation intensity of the sunlight. If it is impeded or changes, for example, due to clouds in the course of the day, voltage fluctuations and current fluctuations occur. A power regulator is usually required to compensate for these fluctuations. The power regulator protects the downstream equipment, such as accumulators, from being overcharged or undercharged. Downstream devices, such as resistance heaters, are voltage-dependent to a considerable extent. Resistance heating elements of this type can burn out even at voltage increases of around 10%. Accordingly, such devices are typically operated via a charge controller.

In addition, it is not possible to directly use the direct voltage output by the photovoltaic module. Feeding into the power grid requires an inverter.

The present invention aims to simplify and improve the use of electrical power from a photovoltaic module. The present invention proposes using the PTC heating device known per se directly for converting electrical energy in the form of a direct current voltage. The DC voltage is the electrical output of the photovoltaic module that is tapped directly at the module. The PTC heating device is electrically connected directly to the photovoltaic module. Any rectifiers or charge controllers that handle and adjust the system-related voltage changes of the photovoltaic module or convert the direct voltage to alternating voltage are omitted. The PTC heating device and the photovoltaic module are preferably manufactured separately from one another The manufacturers of the PTC heating devices considered with the present invention are typically not the same manufacturers that produce photovoltaic modules.

The one or more PTC elements of a PTC heating device have the advantage that they can be operated with a relatively wide voltage range. For example, in a voltage range of between 220 V and 500 V, the PTC elements emit approximately the same thermal output. Short-term voltage peaks do not lead to the destruction of the PTC element. If the voltage exceeds or falls below the operating voltage range outlined above at between 220 V and 500 V, internal electronics can switch off the PTC element or the PTC heating device as a whole. The PTC heating device preferably has an electrical output of at least 1 KW. The electrical output of the PTC heating device can be between 1 KW and 5 KW.

The use according to the invention provides the possibility of direct use of electrical energy from photovoltaic modules. A rectifier is not required. A power regulator is also not required. Instead, a simple disconnection device solely needs to be provided which disconnects the PTC element in the event of voltages outside the operating voltage range.

Due to the direct use of the electrical energy of the photovoltaic module, a high degree of efficiency arises and a low apparatus structure for using the energy of a photovoltaic module. A liquid medium is preferably heated with the PTC heating device. The medium is typically a heat transfer medium which circulates in a circuit in which at least one heat-emitting heat exchanger is provided. Such a heat exchanger can be, for example, a radiator or a different heat exchanger for heating a building, in particular a room in a building, or a facility in the building, such as a swimming pool. A swimming pool arranged outside the building is also a facility of the building in this sense.

In addition, it is also possible to use the generated heat as process heat for the industry.

In this case, the PTC heating device can be only one of several devices introducing heat within the circuit. The PTC heating device can then be integrated into the circuit in series with a heat-introducing heat exchanger. The PTC heating device can act as an additional heat source in the respective circuit and, for example, entirely or in part replace a primary heat-introducing heat exchanger, such as the heat exchanger of a thermal bath, a furnace or a heat pump with which warm heating water and/or warm service water is processed. For example, the PTC heating device can be integrated into a hot water circuit of an existing heating system that is fed with fossil fuels and supplies a single or multi-family house with warm potable or heating water. The PTC heating device can be used to support the heating system. Depending on the total output of the intended photovoltaic modules, a respective PTC heating device can also possibly completely substitute the heat demand of a single or multi-family house.

As shown, the solution according to the invention provides considerable advantages.

If a direct electrical connection between the photovoltaic module and the PTC heating device is presently geared toward, then this means that the direct current of the photovoltaic module is fed directly into the PTC heating device without the interposition of other equipment (apart from the disconnection device) to supply the at least one PTC element of this PTC heating device with electrical energy.

### BRIEF DESCRIPTION OF THE DRAWINGS

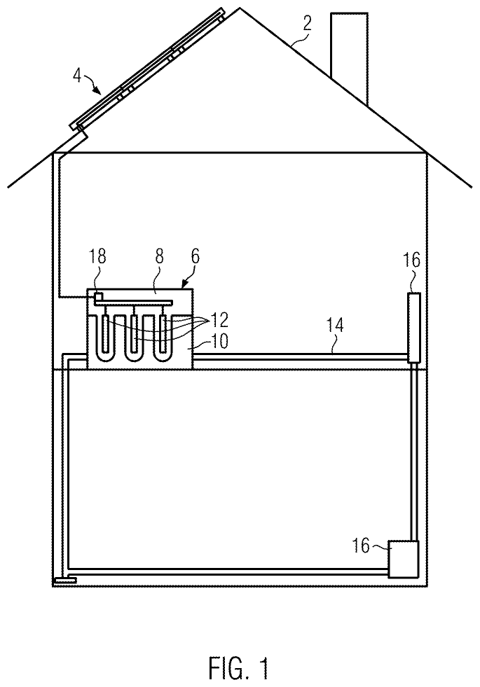

Further advantages and details of the present invention shall arise from the following description of an embodiment in conjunction with the drawing, which in FIG. 1 shows schematically a device for the use of radiant energy from the sun for a heating circuit in a building.

### DETAILED DESCRIPTION

The device shown in FIG. 1 is provided on and/or in a building 2 and comprises a photovoltaic module 4 which is mounted on the roof of the building 2, and a PTC heating device 6 which is arranged in the building 2 and electrically connected to the photovoltaic module 4. The photovoltaic module 4 and the PTC heating device are manufactured separately from one another and provided at a spatial distance from one another.

The PTC heating device 6 is separated into a connection chamber 8 and a heating chamber 10 which are separated from one another in a fluid-tight manner Three PTC elements 12 made of ceramic are arranged in the connection chamber 8, each of which is connected to a partition wall in a thermally conductive manner in a pocket-shaped recess in the partition wall between the connection chamber 8 and the heating chamber 10. The PTC elements 12 are electrically connected to the photovoltaic module and are energized with the direct voltage that the photovoltaic module 4 generates. The heat generated by the PTC elements 12 is transferred via the partition wall to a heat transfer medium, in particular water. The electrical output of the PTC heating device can be in a range between 1 KW and 5 KW.

Conductor tracks are typically provided on the outer side of the PTC elements 12 for introducing and discharging current into and out of the PTC elements 12. Electrical insulation with good thermal conductivity is typically provided between the walls of the pocket-shaped recesses of the partition wall and the conductor tracks. The conductor tracks and the electrical insulation are not shown in the schematic representation.

The heat transfer medium is led in a heating circuit 14 into which the PTC heating device 6 and two heat exchangers 16 configured as radiators are integrated. When circulating through the heating circuit 14, the heat transfer medium flows through the heating chamber 10 of the PTC heating device 6 where it takes up heat, and the heat exchanger 16 where it then gives off heat. Water can be used as the heat transfer medium. The heat exchanger 16 is not restricted to the radiator according to this embodiment. For example, it can also be integrated into underfloor heating or hot water preparation.

The PTC heating device 6 comprises a disconnection device 18 which disconnects the PTC elements 12 in the event of voltages outside a determinable operating voltage range. The determinable operating voltage range can be, for example, between 220 V to 500 V, between 220 V to 750 V, or between 220 V to 1000 V.

1. A PTC heating device, wherein the PTC heating device is configured to directly convert electrical energy in the form of a DC voltage of a photovoltaic module into heat.

2. The PTC heating device according to claim 2, wherein the PTC heating device comprises a thermally conductive heating chamber which is connected to a PTC element and which is integrated into a heating circuit of a building for heating a room or a facility of the building.

3. A device for the use of radiant energy from the sun, the device comprising:
a photovoltaic module that is configured to be exposed to solar radiation and that is configured to convert the solar radiation into electrical energy; and
a PTC heating device with a PTC element that is electrically connected directly to the photovoltaic module and that is connected to a heating chamber in a thermally conductive manner, wherein the heating chamber is integrated into a circuit of a heat transfer medium which is led via at least one heat-emitting heat exchanger.

4. The device according to claim 3, wherein the circuit is led via at least one heat-introducing heat exchanger.

5. The device according to claim 3, further comprising a disconnection device which disconnects the PTC element in the event of voltages outside a determinable operating voltage range.

6. A method for heating a structure, comprising:
producing a DC voltage using a photovoltaic module;
feeding the DC voltage to a PTC heating device with a PTC element that is connected to a heating chamber in a thermally conductive manner;
transferring heat to the structure be circulating a heat transfer medium in a circuit passing through the heating chamber and at least one heat-emitting heat exchanger located in or on the structure.

7. The method according to claim 6, wherein the structure is a building, the circuit is a heating circuit of a building, and said heat-emitting heat exchanger is a radiator.
